(19) United States
(12) Patent Application Publication
(10) Pub. No.: US 2025/0249757 A1
(43) Pub. Date: Aug. 7, 2025

(54) BRAKING CONTROL METHOD AND BRAKING CONTROL SYSTEM OF ELECTRIC MOBILITY

(71) Applicant: HL MANDO CORPORATION, Pyeongtaek (KR)

(72) Inventor: Inha PAICK, Pyeongtaek (KR)

(21) Appl. No.: 18/632,283

(22) Filed: Apr. 11, 2024

(30) Foreign Application Priority Data
Feb. 1, 2024 (KR) 10-2024-0015837

(51) Int. Cl. B60L 15/20; B60T 8/17; B60T 8/171; B60T 8/58; B62J 3/14; B62J 6/24

(52) U.S. Cl. CPC B60L 15/2018; B60T 8/1706; B60T 8/171; B60T 8/58; B62J 3/14; B62J 6/24; B60L 2200/12; B60L 2240/12; B60T 2210/20; B60T 2250/04; B60T 2260/09

(57) ABSTRACT

A braking control method and a braking control system of an electric mobility are provided, and the braking control method of the electric mobility according to an embodiment of the present disclosure comprises: activating a parking brake function; detecting a speed of the electric mobility when activating the parking brake function; if the speed of the electric mobility when activating the parking brake function is 0, short-circuiting a motor; detecting the speed of the electric mobility after short-circuiting the motor; and controlling the motor based on the speed of the electric mobility after short-circuiting the motor.

### CROSS-REFERENCE TO RELATED APPLICATION

This application claims the benefit of and priority to Korean Patent Application No. 2024-0015837 filed on Feb. 1, 2024, the entire disclosures of which are incorporated herein by reference.

### TECHNICAL FIELD

The present disclosure relates to a braking control method and a braking control system of an electric mobility. More specifically, the present disclosure relates to a braking control method and a braking control system of the electric mobility that enable a parking brake function to be performed without a separate parking brake device.

### BACKGROUND

Regular bicycles and electric bicycles use mechanical parking brake devices that hold the wheels of the bicycles.

However, this general parking brake using cables requires a separate hardware device, and for example, when parking a heavy 3-4 wheeled cargo bike on a steep hill, it may take a lot of force to hold or release the lever.

In addition, there is a problem that the management is difficult in that maintenance of the brake cables and brake pads used in the parking brake device is required.

Therefore, there is a need for a braking control method and a braking control system for the electric mobility (including electric bicycles and e-cargo bikes) that reduce the inconvenience of the parking brake device and allow to perform the parking brake function without applying the driver's force.

### SUMMARY

The present disclosure is to solve the above-mentioned problems of the prior art, and the object of the present disclosure is to provide a braking control method and a braking control system of an electric mobility that can perform a parking brake function by controlling the motor of the electric mobility.

In addition, the object of the present disclosure is to provide a braking control method and a braking control system of the electric mobility that enable stable parking without a separate parking brake device even if the road surface is inclined when parking the electric mobility.

However, the technical problem to be achieved by the embodiments of the present disclosure is not limited to the technical problems described above, and other technical problems may exist.

As a technical means for achieving the above technical problem, a braking control method of an electric mobility according to an embodiment of the present disclosure comprises: activating a parking brake function; detecting a speed of the electric mobility when activating the parking brake function; if the speed of the electric mobility when activating the parking brake function is 0, short-circuiting a motor; detecting the speed of the electric mobility after short-circuiting the motor; and controlling the motor based on the speed of the electric mobility after short-circuiting the motor.

Further, if it is detected that the speed of the electric mobility when activating the parking brake function is not 0, the parking brake function may be deactivated.

Further, if it is detected that the speed of the electric mobility after short-circuiting the motor is 0, short-circuiting of the motor may be maintained.

Further, if it is detected that the speed of the electric mobility after short-circuiting the motor is greater than 0, the controlling of the motor may comprise controlling a motor torque to be applied in a reverse direction.

Further, the controlling of the motor torque to be applied in the reverse direction may further comprise generating a visual or audible alarm through a warning device.

Further, if it is detected that the speed of the electric mobility after short-circuiting the motor is less than 0, the controlling of the motor may comprise controlling a motor torque to be applied in a forward direction.

Further, the controlling of the motor torque to be applied in the forward direction may further comprise generating a visual or audible alarm through a warning device.

A braking control method of an electric mobility according to another embodiment of the present disclosure comprises: activating a parking brake function; detecting a speed of the electric mobility when activating the parking brake function; if the speed of the electric mobility when activating the parking brake function is 0, short-circuiting the motor; detecting an inclination of a road surface on which the electric mobility is located; and controlling the motor based on the inclination of the road surface.

Further, if it is detected that the speed of the electric mobility when activating the parking brake function is not 0, the parking brake function may be deactivated.

Further, if it is detected that the inclination of the road surface is less than 0, the controlling of the motor may comprise controlling a motor torque to be applied in a reverse direction.

Further, the controlling of the motor torque to be applied in the reverse direction may comprise: calculating an inclination degree of downhill of the road surface; determining a required torque value according to the inclination degree of downhill of the road surface; and applying the motor torque according to the determined required torque value in the reverse direction.

Further, if it is detected that the inclination of the road surface is greater than 0, the controlling of the motor may comprise controlling a motor torque to be applied in a forward direction.

Further, the controlling of the motor torque to be applied in the forward direction may comprise: calculating an inclination degree of uphill of the road surface; determining a required torque value according to the inclination degree of uphill of the road surface; and applying the motor torque according to the determined required torque value in the forward direction.

A braking control system of an electric mobility according to embodiments of the present disclosure comprises: an operation button configured to activate a parking brake function; a speed sensor configured to detect a speed of the electric mobility; an inclination sensor configured to detect an inclination of the road surface on which the electric mobility is located; a main battery; a controller configured to control the electric mobility; and a motor configured to drive the electric mobility, wherein if the speed of the electric mobility when activating the parking brake function is 0, the controller is configured to short-circuit the motor, and control the motor based on the speed of the electric mobility or based on the inclination of the road surface after short-circuiting the motor.

Further, if it is determined that the speed of the electric mobility after short-circuiting the motor is greater than 0, the controller may be configured to control the motor such that a motor torque is applied in a reverse direction.

Further, if it is determined that the speed of the electric mobility after short-circuiting the motor is less than 0, the controller may be configured to control the motor such that a motor torque is applied in a forward direction.

Further, if it is detected that the inclination of the road surface after short-circuiting the motor is less than 0, the controller may be configured to: calculate an inclination degree of downhill of the road surface detected by the inclination sensor; determine a required torque value according to the inclination degree of downhill of the road surface; and control the motor such that a motor torque is applied according to the determined required torque value in a reverse direction.

Further, if it is detected that the inclination of the road surface after short-circuiting the motor is greater than 0, the controller may be configured to: calculate an inclination degree of uphill of the road surface detected by the inclination sensor; determine a required torque value according to the inclination degree of uphill of the road surface; and control the motor such that a motor torque is applied according to the determined required torque value in a forward direction.

The braking control system of the electric mobility may further comprise an auxiliary battery provided separately from the main battery, and the braking control system of the electric mobility may be configured to be operated with the auxiliary battery without using the main battery.

The braking control system of the electric mobility may further comprise a warning device configured to generate a visual or audible alarm, and the controller may be configured to control the warning device to generate the visual or audible alarm in addition to controlling the motor.

The above-described means for solving the problem is only exemplary and should not be construed as limiting the present disclosure. In addition to the exemplary embodiments described above, additional embodiments may exist in the drawings and the following detailed description.

According to the above-described problem-solving means of the present disclosure, it is possible to provide a braking control method and a braking control system of an electric mobility that perform a parking brake function by controlling a motor without a separate parking brake device.

In addition, according to the above-described problem-solving means of the present disclosure, it is possible to provide a braking control method and a braking control system of an electric mobility that enables more stable parking by detecting an inclination of a parking position of the electric mobility and then calculating a required motor torque value to perform a braking control.

However, the effects obtainable from the present disclosure are not limited to the effects described above, and other effects may exist.

### BRIEF DESCRIPTION OF THE DRAWINGS

FIG. 1A is a flowchart showing a braking control method of an electric mobility according to an embodiment of the present disclosure, and FIG. 1B is a flow chart showing the step of controlling the motor more specifically in the braking control method of the electric mobility according to the embodiment of the present disclosure.

FIG. 2A is a flowchart showing a braking control method of the electric mobility according to another embodiment of the present disclosure, and FIG. 2B is a flow chart showing the step of controlling the motor more specifically in the braking control method of the electric mobility according to another embodiment of the present disclosure.

FIG. 3 is a flow chart showing the step of applying the motor torque in the reverse direction more specifically in the braking control method of the electric mobility according to another embodiment of the present disclosure.

FIG. 4 is a flowchart showing the step of applying the motor torque in the forward direction more specifically in the braking control method of the electric mobility according to another embodiment of the present disclosure.

FIGS. 5A and 5B are control block diagrams schematically showing a braking control system of the electric mobility according to the embodiment of the present disclosure.

FIGS. 6A and 6B are control block diagrams schematically showing a braking control system of the electric mobility according to another embodiment of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part “includes” a certain component, it does not mean excluding other components, and it does mean that it may further include other components, unless otherwise stated.

Various embodiments of the present disclosure generally relate to a braking control method and a braking control system of an electric mobility that perform a parking brake function through a motor control.

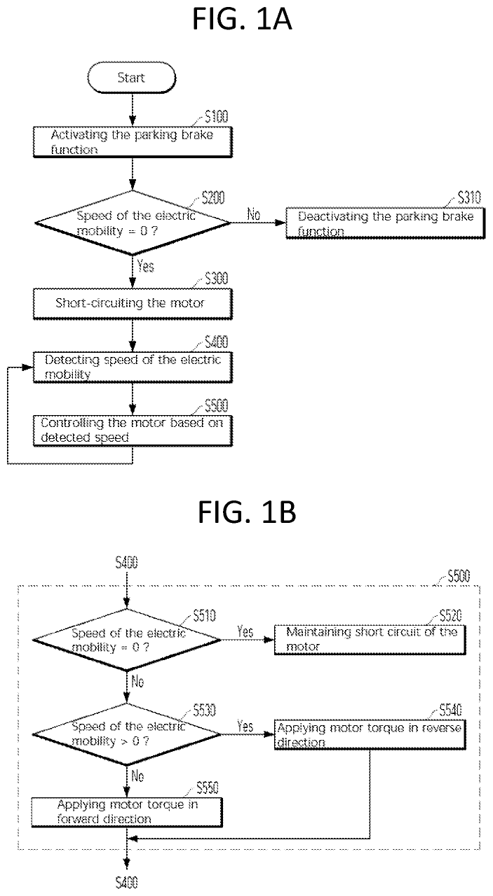

FIG. 1A is a flowchart showing a braking control method of an electric mobility according to an embodiment of the present disclosure, and FIG. 1B is a flow chart showing the step of controlling the motor more specifically in the braking control method of the electric mobility according to the embodiment of the present disclosure.

Referring to FIG. 1A, the braking control method of the electric mobility according to the embodiment of the present disclosure may include a step of activating the parking brake function S100 for activating the parking brake function, a step of detecting a speed of the electric mobility when activating the parking brake function S200, a step of short-circuiting a motor circuit S300 if the speed of the electric mobility is 0 when activating the parking brake function (‘Yes’ in S200), a step of detecting the speed of the electric mobility after short-circuiting the motor circuit S400, and a step of controlling the motor based on the speed of the electric mobility after short-circuiting the motor circuit S500.

First, activating the parking brake function S100 may be performed, for example, by operating the parking brake operation button installed at the electric mobility. Since the embodiment of the present disclosure may be intended to perform the parking brake function by controlling the motor without a parking brake device that physically holds the wheels of the electric mobility, operating the parking brake operation button may be an action to control the motor.

Next, the speed of the electric mobility when activating the parking brake function may be detected (S200). Since the parking brake function is preferably activated when the electric mobility is stationary, the speed of the electric mobility may be detected to determine whether the speed of the electric mobility is 0 (zero) when the parking brake function is activated.

If the speed of the electric mobility when activating the parking brake function is 0 (‘Yes’ in S200), the motor may be prevented from operating by short-circuiting the motor (S300). On the other hand, if the speed of the electric mobility is not 0 when activating the parking brake (‘No’ in S200), that is, if the parking brake function is activated while the electric mobility is moving, the parking brake function may be deactivated (S310).

Next, detecting the speed of the electric mobility after short-circuiting the motor S400 may be performed. That is, after short-circuiting the motor, the speed of the electric mobility may be detected to determine whether the electric mobility is stationary or moving.

Next, a motor control step S500 may be performed by controlling the motor based on the speed of the electric mobility after short-circuiting the motor. If the speed of the electric mobility after short-circuiting the motor is not 0 (zero), that is, if the electric mobility moves while the parking brake function is activated, it may be due to an external force applied to the electric mobility or a slope of the road surface. In this case, a motor control step may be performed to control the motor to suppress the movement of the electric mobility through an intervention of the motor.

Looking in more detail at the motor control step S500 according to the embodiment of the present disclosure with reference to FIG. 1B, the motor control step S500 may include determining whether the speed of the electric mobility is 0 after short-circuiting the motor S510.

If the speed of the electric mobility after short-circuiting the motor is 0 (‘Yes’ in S510), since the electric mobility is in a stationary state, it may be controlled to maintain the short-circuit of the motor (S520). This is because no additional intervention of the motor is required since the electric mobility remains stopped even after the parking brake function is activated.

If the speed of the electric mobility after short-circuiting the motor is not 0 (‘No’ in S510), it may be additionally determined whether the speed of the electric mobility is greater than 0 (S530).

If the speed of the electric mobility is detected to be greater than 0 (‘Yes’ in S530), the motor torque may be controlled to be applied in a reverse direction (S540). That is, in the case where the electric mobility is about to move forward after short-circuiting the motor, the electric mobility may be controlled to remain stationary by immediately applying the motor torque in the opposite direction.

In addition, if the speed of the electric mobility after short-circuiting the motor is detected to be greater than 0, a visual or audible alarm may be generated in addition to controlling the motor torque to be applied in the reverse direction.

Through generating the alarm, for example, if the electric mobility is located on an inclined place, the driver may immediately recognize that the electric mobility is on the inclined place, enabling a safe exit when the driver gets off the electric mobility.

In addition, even if the electric mobility is located on a flat place, if there is a risk of theft, such as a third party trying to move the electric mobility by applying force, it is possible to prevent the risk of theft by generating the alarm.

Meanwhile, if the speed of the electric mobility is detected to be less than 0 (‘No’ in S530), the motor torque may be controlled to be applied in a forward direction (S550). That is, in the case where the electric mobility is about to move backward after short-circuiting the motor, the electric mobility may be controlled to remain stationary by immediately applying the motor torque in the forward direction.

In addition, in case that the speed of the electric mobility after short-circuiting the motor is detected to be less than 0, in addition to controlling the motor torque to be applied in the forward direction, a visual or audible alarm may be generated.

Through generating the alarm, as described above, it is possible to allow the driver to safely get off the electric mobility when the electric mobility is located on an inclined place, and it is possible to prevent the risk of theft.

Meanwhile, even in case that the parking brake function cannot be properly performed due to a malfunction of the parking brake function, the visual or audible alarm may be generated, thereby enabling to cope with the system errors.

Further, after the step of applying the motor torque in the reverse direction S540 or the step of applying the motor torque in the forward direction S550, the step of detecting the speed of the electric mobility 400 and the step of controlling the motor S500 may be performed again, thereby controlling the electric mobility to be in a stationary state continuously.

According to the embodiment of the present disclosure as described above, after activating the parking brake function while the electric mobility is stationary, by controlling the motor to prevent the electric mobility from moving depending upon the speed of the electric mobility after short-circuiting the motor, it is possible to achieve the parking brake function without a separate parking brake device (a hardware device).

Further, by generating the visual or audible alarm in addition to controlling the motor torque, it is possible to promote the safety of the driver of the electric mobility and effectively prevent a possible theft from occurring.

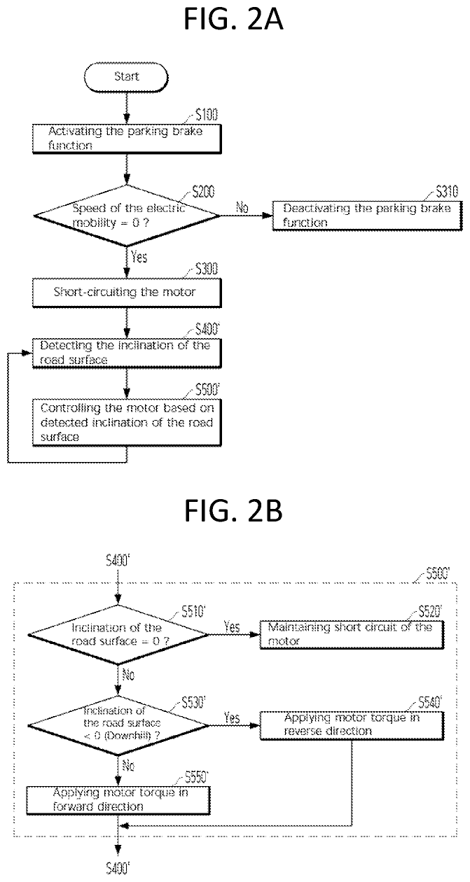

FIG. 2A is a flowchart showing a braking control method of the electric mobility according to another embodiment of the present disclosure, and FIG. 2B is a flow chart showing the step of controlling the motor more specifically in the braking control method of the electric mobility according to another embodiment of the present disclosure.

As shown in FIG. 2A, the braking control method of the electric mobility according to another embodiment of the present disclosure may include a step of activating the parking brake function S100 for activating the parking brake function, a step of detecting a speed of the electric mobility when activating the parking brake function S200, a step of short-circuiting a motor circuit S300 if the speed of the electric mobility is 0 when activating the parking brake function (‘Yes’ in S200), a step of detecting an inclination of a road surface on which the electric mobility is located S400′, and a step of controlling the motor based on the detected inclination of the road surface S500′.

As in the previous embodiment, if it is detected that the speed of the electric mobility when activating the parking brake function is not 0 (‘No’ in S200), it may be controlled to deactivate the parking brake function (S310).

Meanwhile, in the embodiment of FIGS. 2A and 2B, unlike the previous embodiment of FIGS. 1A and 1B, a step of detecting the inclination of the road surface S400′ for detecting the inclination of the road surface on which the electric mobility is located may be performed after short-circuiting the motor.

Detecting the inclination of the road surface is because the electric mobility may move due to gravity if the road surface is uphill or downhill. On the other hand, if the road surface is flat, it may be determined that the electric mobility is stationary, and additional intervention of the motor may not be required. The inclination of the road surface may be measured (detected) by an inclination sensor such as a G-sensor.

After the step of detecting the inclination of the road surface S400′, a motor control step S500′ of controlling the motor based on the detected inclination of the road surface may be performed, thereby suppressing the movement of the electric mobility. Accordingly, the parking brake function can be achieved through the motor control.

Looking more specifically at the motor control step of controlling the motor based on the detected inclination of the road surface with reference to FIG. 2B, the motor control step may include determining whether the inclination of the road surface is 0 (S510′). If the inclination of the road surface after short-circuiting the motor is 0 (‘Yes’ in S510′), the short circuit of the motor may be maintained (S520′).

On the other hand, if the inclination of the road surface is not 0 (‘No’ in S510′), it may be determined whether the inclination of the road surface is less than 0 (S530′), and if the inclination is less than 0, that is, if it is downhill based on the moving direction of the electric mobility (‘Yes’ in S530′), the motor torque may be controlled to be applied in the reverse direction (S540′).

By controlling the motor in this way, it is possible to maintain the stationary state of the electric mobility to achieve the parking brake function by suppressing the electric mobility from moving forward due to the inclination of the road surface.

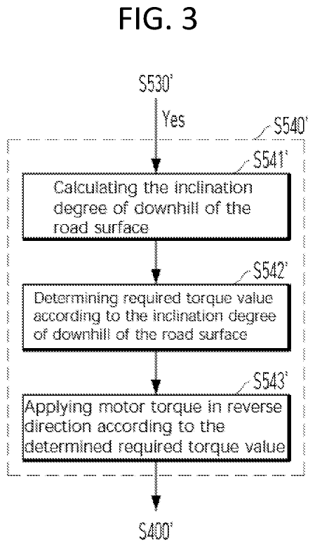

FIG. 3 is a flow chart showing the step of applying the motor torque in the reverse direction more specifically in the braking control method of the electric mobility according to another embodiment of the present disclosure.

Looking more specifically with reference to FIG. 3, the step of controlling the motor torque to be applied in the reverse direction S540′ may include the step of calculating the inclination degree of downhill of the road surface S541′, a step of determining the required torque value according to the inclination degree of downhill of the road surface S542′, and a step of applying the motor torque in the reverse direction according to the determined required torque value S543′.

Here, the inclination degree of downhill (degree of the slope) of the road surface may be calculated in % or degree (angle), and based on the calculated inclination degree, a control value (required torque value) by which the speed of the electric mobility becomes 0 (kph) may be determined.

That is, by previously determining the required torque value using the inclination sensor, and by applying the motor torque according to the previously determined required torque value when the electric mobility is about to move forward, it is possible to apply an appropriate motor torque to prevent the movement (to cause the speed of the electric mobility to be zero).

Therefore, it is possible to effectively prevent the electric mobility from moving due to the inclination of the road surface, and it is possible to minimize the movement of the electric mobility that may occur due to insufficient control torque amount when applying the torque.

Referring again to FIG. 2B, if the inclination of the road surface is greater than 0, that is, if the road surface is uphill based on the moving direction of the electric mobility (‘No’ in S530′), the motor torque may be controlled to be applied in the forward direction (S550′).

By controlling the motor in this way, it is possible to maintain a stationary state and achieve the parking brake function by suppressing the electric mobility from moving backward due to the inclination of the road surface.

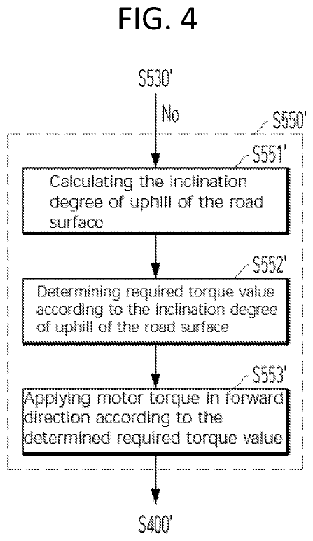

FIG. 4 is a flowchart showing the step of applying the motor torque in the forward direction more specifically in the braking control method of the electric mobility according to another embodiment of the present disclosure.

Looking more specifically with reference to FIG. 4, the step of controlling the motor torque to be applied in the forward direction S550′ may include a step of calculating the inclination degree of uphill of the road surface S551′, a step of determining a required torque value according to the inclination degree of uphill of the road surface S552′, and a step of applying the motor torque in the forward direction according to the determined required torque value S553′.

Accordingly, by previously determining the required torque value using the inclination sensor, and by applying the motor torque according to the previously determined required torque value when the electric mobility is about to move backward, it is possible to apply an appropriate motor torque to prevent the movement (to cause the speed of the electric mobility to be zero).

Further, in the embodiment of FIGS. 2A and 2B, a visual or audible alarm may be generated through a warning device along with applying the motor torque in the reverse direction or in the forward direction.

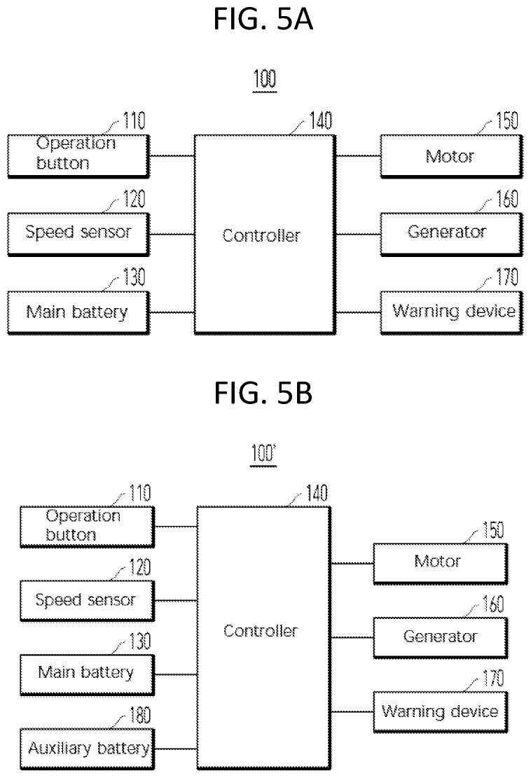

FIGS. 5A and 5B are control block diagrams schematically showing a braking control system of the electric mobility according to the embodiment of the present disclosure.

Referring to FIG. 5A, the braking control system of the electric mobility 100 according to an embodiment of the present disclosure may include an operation button 110 configured to activate the parking brake function, a speed sensor 120 configured to detect the speed of the electric mobility, a main battery 130, a controller 140 configured to control the electric mobility, and a motor 150 configured to drive the electric mobility.

If the speed of the electric mobility when activating the parking brake function is 0, the controller 140 may short-circuit the motor 150, and control the motor 150 based on the speed of the electric mobility after short-circuiting the motor 150.

Specifically, if it is detected that the speed of the electric mobility after short-circuiting the motor 150 is greater than 0, the controller 140 may control the motor 150 such that the motor torque is applied in the reverse direction.

Further, if it is detected that the speed of the electric mobility after short-circuiting the motor 150 is less than 0, the controller 140 may control the motor 150 such that the motor torque is applied in the forward direction.

In addition, the braking control system of the electric mobility 100 according to the embodiment of the present disclosure may include a generator 160, and for example, the main battery 130 may be charged by generating electrical energy through the rotation of a pedal serving as the generator 160.

Further, the braking control system of the electric mobility 100 according to the embodiment of the present disclosure may further include a warning device 170 configured to generate a visual or audible alarm, and the controller may control the motor 150 such that the motor torque is applied in the reverse or the forward direction and may control the warning device 170 to generate the visual or audible alarm.

FIG. 5B shows an embodiment of a braking control system of the electric mobility 100′ that additionally includes an auxiliary battery 180. The braking control system of the electric mobility 100′ including the auxiliary battery 180 may be configured to be operated with the auxiliary battery 180 without using the main battery 130.

In this regard, in implementing the braking control method according to the embodiments of the present disclosure, there may be a problem that the power of the electric mobility is required to be turned on at all the time. In this way, if the power is turned on all the time, problems may occur such as the driving distance of the electric mobility is reduced due to unnecessary energy consumption.

In contrast, by installing a separate auxiliary battery 180 as shown in FIG. 5B, consumption of the main battery can be avoided, and in addition, the auxiliary battery 180 can be charged by pedal power generation or regenerative braking of the motor when driving the electric mobility, thereby achieving the efficient battery use.

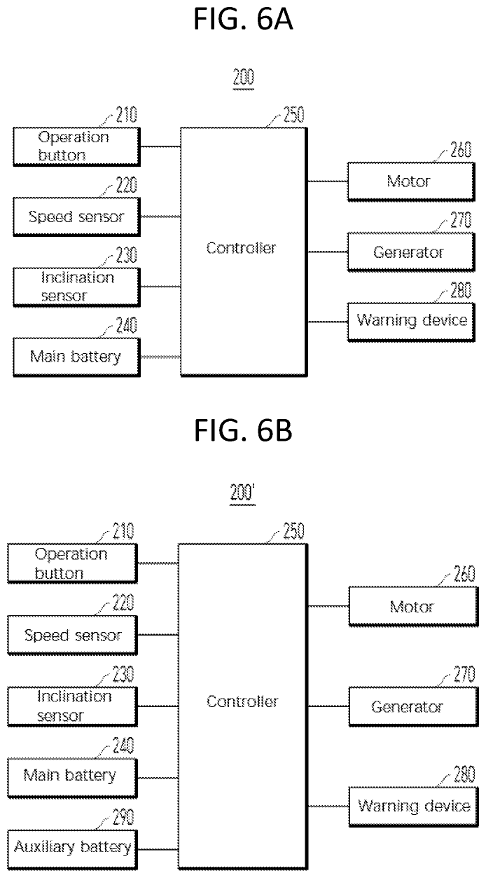

FIGS. 6A and 6B are control block diagrams schematically showing a braking control system of the electric mobility according to another embodiment of the present disclosure.

As shown in FIGS. 6A and 6B, a braking control system of the electric mobility 200 according to another embodiment of the present disclosure may further include an inclination sensor 230 configured to detect the inclination of the road surface on which the electric mobility is located, in addition to an operation button 210, a speed sensor 220, a main battery 240, a controller 250 and the motor 260.

In addition, as shown in FIG. 6A, a generator 270 configured to generate electrical energy and a warning device 280 configured to perform a visual or audible warning may be additionally provided in the embodiments of FIGS. 6A and 6B.

In this embodiment, the inclination of the road surface on which the electric mobility is located may be measured using the inclination sensor 230, for example, a G-sensor.

If the speed of the electric mobility when activating the parking brake function is 0, the controller 250 may short-circuit the motor 260 and may control the motor 260 based on the inclination of the road surface after short-circuiting the motor 260.

For example, If it is detected that the inclination of the road surface after short-circuiting the motor 260 is less than 0, the controller 250 may calculate the inclination degree of downhill of the road surface detected by the inclination sensor, determine the required torque value according to the inclination degree of downhill of the road surface, and control the motor such that the motor torque according to the determined required torque value is applied in the reverse direction.

If it is detected that the inclination of the road surface after short-circuiting the motor 260 is greater than 0, the controller 250 may calculate the inclination degree of uphill of the road surface detected by the inclination sensor and, determine the required torque value according to the inclination degree of uphill of the road surface, and control the motor such that the motor torque according to the determined required torque value is applied in the forward direction.

By controlling the motor in this way, an appropriate motor torque can be applied according to the inclination degree the road surface, thereby effectively suppressing movement caused by insufficient torque control, and achieving more stable parking brake function.

In addition, FIG. 6B shows an embodiment of a braking control system of the electric mobility 200′ that additionally includes an auxiliary battery 290, and as shown in the embodiment of FIG. 5B, using the auxiliary battery enables the efficient battery use.

According to the embodiments of the present disclosure as described above, a motor control method and a motor control system of an electric mobility capable of performing a parking brake function can be provided without using a separate parking brake device.

Further, according to the embodiments of the present disclosure, after detecting the inclination degree of the road surface, by previously calculating the required torque value according to the inclination degree and by applying the appropriate motor torque when controlling the motor, it is possible to provide the motor control method and the motor control system of the electric mobility enabling to operate a stable parking brake function.

Furthermore, according to the embodiments of the present disclosure, the driver's safety and theft prevention effect can be promoted by generating alarms by the warning device along with the motor control, and also efficient battery use can be achieved by operating the braking control system by the use of the auxiliary battery.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

### EXPLANATION OF REFERENCE

100, 100′, 200, 200′: Braking control system of electric mobility
110, 210: Operation button
120, 220: Speed sensor
130, 240: Main battery
140, 250: Controller
150, 260: Motor
160, 270: Generator
170, 280: Warning device
180, 290: Auxiliary battery
230: Inclination sensor

What is claimed is:

1. A braking control method of an electric mobility, comprising:
activating a parking brake function;
detecting a speed of the electric mobility when activating the parking brake function;
if the speed of the electric mobility when activating the parking brake function is 0, short-circuiting a motor;
detecting the speed of the electric mobility after short-circuiting the motor; and
controlling the motor based on the speed of the electric mobility after short-circuiting the motor.

2. The braking control method of claim 1, wherein if it is detected that the speed of the electric mobility when activating the parking brake function is not 0, the parking brake function is deactivated.

3. The braking control method of claim 1, wherein if it is detected that the speed of the electric mobility after short-circuiting the motor is 0, short-circuiting of the motor is maintained.

4. The braking control method of claim 1, wherein if it is detected that the speed of the electric mobility after short-circuiting the motor is greater than 0, the controlling of the motor comprises controlling a motor torque to be applied in a reverse direction.

5. The braking control method of claim 4, wherein the controlling of the motor torque to be applied in the reverse direction further comprises generating a visual or audible alarm through a warning device.

6. The braking control method of claim 1, wherein if it is detected that the speed of the electric mobility after short-circuiting the motor is less than 0, the controlling of the motor comprises controlling a motor torque to be applied in a forward direction.

7. The braking control method of claim 6, wherein the controlling of the motor torque to be applied in the forward direction further comprises generating a visual or audible alarm through a warning device.

8. A braking control method of an electric mobility, comprising:
activating a parking brake function;
detecting a speed of the electric mobility when activating the parking brake function;
if the speed of the electric mobility when activating the parking brake function is 0, short-circuiting the motor;
detecting an inclination of a road surface on which the electric mobility is located; and
controlling the motor based on the inclination of the road surface.

9. The braking control method of claim 8, wherein if it is detected that the speed of the electric mobility when activating the parking brake function is not 0, the parking brake function is deactivated.

10. The braking control method of claim 8, wherein if it is detected that the inclination of the road surface is less than 0, the controlling of the motor comprises controlling a motor torque to be applied in a reverse direction.

11. The braking control method of claim 10, wherein the controlling of the motor torque to be applied in the reverse direction comprises: calculating an inclination degree of downhill of the road surface; determining a required torque value according to the inclination degree of downhill of the road surface; and applying the motor torque according to the determined required torque value in the reverse direction.

12. The braking control method of claim 8, wherein if it is detected that the inclination of the road surface is greater than 0, the controlling of the motor comprises controlling a motor torque to be applied in a forward direction.

13. The braking control method of claim 12, wherein the controlling of the motor torque to be applied in the forward direction comprises: calculating an inclination degree of uphill of the road surface; determining a required torque value according to the inclination degree of uphill of the road surface; and applying the motor torque according to the determined required torque value in the forward direction.

14. A braking control system of an electric mobility, comprising:
an operation button configured to activate a parking brake function;
a speed sensor configured to detect a speed of the electric mobility;
an inclination sensor configured to detect an inclination of the road surface on which the electric mobility is located;
a main battery;
a controller configured to control the electric mobility; and
a motor configured to drive the electric mobility,
wherein if the speed of the electric mobility when activating the parking brake function is 0, the controller is configured to short-circuit the motor, and control the motor based on the speed of the electric mobility or based on the inclination of the road surface after short-circuiting the motor.

15. The braking control system of claim 14, wherein if it is determined that the speed of the electric mobility after short-circuiting the motor is greater than 0, the controller is configured to control the motor such that a motor torque is applied in a reverse direction.

16. The braking control system of claim 14, wherein if it is determined that the speed of the electric mobility after short-circuiting the motor is less than 0, the controller is configured to control the motor such that a motor torque is applied in a forward direction.

17. The braking control system of claim 14, wherein if it is detected that the inclination of the road surface after short-circuiting the motor is less than 0, the controller is configured to:
calculate an inclination degree of downhill of the road surface detected by the inclination sensor;
determine a required torque value according to the inclination degree of downhill of the road surface; and control the motor such that a motor torque is applied according to the determined required torque value in a reverse direction.

18. The braking control system of claim 14, wherein if it is detected that the inclination of the road surface after short-circuiting the motor is greater than 0, the controller is configured to:
calculate an inclination degree of uphill of the road surface detected by the inclination sensor;
determine a required torque value according to the inclination degree of uphill of the road surface;
and control the motor such that a motor torque is applied according to the determined required torque value in a forward direction.

19. The braking control system of claim 14, further comprising an auxiliary battery provided separately from the main battery,
wherein the braking control system of the electric mobility is configured to be operated with the auxiliary battery without using the main battery.

20. The braking control system of claim 15, further comprising a warning device configured to generate a visual or audible alarm,
wherein the controller is configured to control the warning device to generate the visual or audible alarm in addition to controlling the motor.
